(19) United States
(12) Patent Application Publication
(10) Pub. No.: US 2011/0148738 A1
(43) Pub. Date: Jun. 23, 2011

(54) OPENING/CLOSING TYPE ELECTROMAGNETIC WAVE ABSORBING DEVICE

(75) Inventor: Dong-Uk SIM, Daejeon (KR)

(73) Assignee: ELECTRONICS AND TELECOMMUNICATION RESEARCH INSTITUTE, Daejeon (KR)

(21) Appl. No.: 12/943,161

(22) Filed: Nov. 10, 2010

(30) Foreign Application Priority Data
Dec. 18, 2009 (KR) 10-2009-0127091

(51) Int. Cl. H01Q 15/10

(52) U.S. Cl. 343/909

(57) ABSTRACT

An opening/closing type electromagnetic wave absorbing device is provided. The opening/closing type electromagnetic wave absorbing device includes, a plurality of electromagnetic band gap (EBG) unit cells each of which is polygonal and selectively transmits or reflects a wave with a predetermined frequency and an opening/closing means on which the plurality of EBG unit cells are periodically arranged to selectively open and close a limited space, wherein each of the plurality of EBG unit cells includes a metallic conductive ground layer; a dielectric layer formed on the metallic conductive ground layer; an EBG unit cell pattern layer formed of a resistive material on the dielectric layer.

### CROSS-REFERENCE TO RELATED APPLICATION

This application claims priority to and the benefit of Korean Patent Application No. 10-2009-0127091 filed in the Korean Intellectual Property Office on Dec. 18, 2009, the entire contents of which are incorporated herein by reference.

### BACKGROUND OF THE INVENTION

(a) Field of the Invention

The present invention relates to an electromagnetic wave absorbing device. More particularly, the present invention relates to an opening/closing type electromagnetic wave absorbing device

(b) Description of the Related Art

Recently, because of sharp growth of IT and a greater human desire to communication, wireless communication devices, such as portable terminals, have became a must-have in modern society. As the use of portable devices increases, an effect of electromagnetic waves generated from the devices on the human body becomes a critical issue.

To date, it is not clear whether electromagnetic wave with a frequency band employed for cellular phones affects the human body. However, there are some reports that electromagnetic wave may cause various diseases, such as leukemia, brain cancer, headache, falling eyesight, brainwave disorder, or hypogonadism. Further, life intrusions due to malfunction of communication devices by unwanted electromagnetic waves and reckless use of communication devices have been continuously reported.

For example, unwanted electromagnetic wave can cause a malfunction of a precision instrument used in hospitals or laboratories, or have a negative effect on people who works in an environment exposed to harmful electromagnetic waves. And, indiscriminate use of communication devices in public, such as schools, theaters, performance halls, religious gatherings, may make others inconvenient. Accordingly, there has been studied research to effectively shield electromagnetic waves and prevent people from being negatively affected.

In the related art, there has been a technology to reduce an effect by electromagnetic waves by using electromagnetic band gap (EBG) and electromagnetic wave absorber to shield electromagnetic waves.

The EBG technology periodically forms an artificial metallic pattern on a substrate made of a dielectric material to change the electromagnetic characteristics originally possessed by the metal. This technology is also called “artificial magnetic conductor (AMC)” since magnetic conductive characteristics non-existent in nature are artificially implemented on existing metallic conductor, or called “high impedance surface (HIS)” because of having a high impedance surface. A band gap occurs at a specific band due to the EBG surface with high impedance. The band gap reduces a surface current to inhibit the generation of surface wave. In the EBG, however, a number of unit cells having a metal pattern cannot completely reduce the surface current and the specific absorption rate (SAR) of the electromagnetic waves is larger than that of a shield.

Electromagnetic wave absorbers may be variously classified depending on shape, material, or absorption mechanism. Most of current electromagnetic wave absorbers include compositions having absorption characteristics. In general, an electromagnetic wave absorber is developed through trials and errors and thus its manufacturing process is complicated. Further, it is considerably difficult to adjust absorption frequency bands and absorption characteristics.

On the contrary, a plate type resonant electromagnetic wave absorber, such as a λ/4 wave absorber or Salisbury screen has a simple structure including a resistive sheet, a dielectric spacer, and a metallic conductive ground layer. Accordingly, this type of absorber has an advantages, such as ease-to-manufacture, ease-to-adjust absorption capability, and multi-band absorption characteristics when being formed in multi layers. However, a Salisbury screen has a disadvantage that the thickness of the dielectric space from the metallic conductive ground surface should be more than at least λ/4.

Therefore, there is a need for an electromagnetic wave absorber that may be simply manufactured, easily adjust the absorption frequency band and absorption characteristics, and have a further reduced thickness.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide provides an opening/closing type electromagnetic wave absorbing device having advantages of being simply manufactured by using a periodic structure technology, such as EBG, and a resistive material, easily adjust thickness as well as the absorption frequency bands and absorption characteristics through control of parameters, and selectively absorb electromagnetic waves when desired by a user.

An exemplary embodiment of the present invention provides an opening/closing type electromagnetic wave absorbing device including: a plurality of electromagnetic band gap (EBG) unit cells each of which is polygonal and selectively transmits or reflects a wave with a predetermined frequency; and an opening/closing means on which the plurality of EBG unit cells are periodically arranged to selectively open and close a limited space, wherein each of the plurality of EBG unit cell includes a metallic conductive ground layer; a dielectric layer formed on the metallic conductive ground layer; an EBG unit cell pattern layer formed of a resistive material on the dielectric layer.

The EBG unit cell pattern layer adjusts an absorption frequency band and an absorption characteristic by controlling a structural parameter of the EBG.

### BRIEF DESCRIPTION OF THE DRAWINGS

FIG. 1 is a cross section view illustrating part of an electromagnetic wave absorbing device according to an exemplary embodiment of the present invention.

FIG. 2 is a view illustrating an absorbing concept of an electromagnetic wave absorbing device according to an exemplary embodiment of the present invention.

FIGS. 3A and 3B illustrate a pattern structure of a unit cell and design parameters of the unit cell pattern structure according to a first exemplary embodiment of the present invention.

FIG. 4 is a graph illustrating electromagnetic wave absorption bands and absorption capability results of the unit cell pattern structure according to the first exemplary embodiment of the present invention.

FIG. 5 is a plan view illustrating a pattern structure of a unit cell according to a second exemplary embodiment of the present invention.

FIG. 6 is a photograph illustrating an electromagnetic wave absorber actually manufactured based on the unit cell structure according to the second exemplary embodiment.

FIG. 7 is a graph illustrating electromagnetic wave absorption bands and results of absorption capability obtained by using the unit cell pattern structure according to the second exemplary embodiment of the present invention.

FIG. 8 is a graph illustrating results of absorption capability depending on variation of the surface resistance Rs of a unit cell pattern in a unit cell structure according to a second exemplary embodiment of the present invention.

FIG. 9 is a plan view illustrating a pattern structure of a unit cell according to a third exemplary embodiment of the present invention.

FIG. 10 is a graph illustrating simulated results depending on a parameter, such as the length x of a side of the third slot, according to the third exemplary embodiment of the present invention.

FIG. 11 is a graph illustrating results of absorption capability obtained by applying a different surface resistance Rs for each unit cell pattern in a unit cell structure according to an exemplary embodiment of the present invention.

FIG. 12 is a graph illustrating results of absorption capability obtained by applying a different surface resistance Rs for each unit cell pattern in a unit cell structure actually manufactured according to an exemplary embodiment of the present invention.

FIG. 13 is a view illustrating an electromagnetic wave absorbing device manufactured in a blind type according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In specification, unless explicitly described to the contrary, the word “comprise” and variations such as “comprises” or “comprising”, will be understood to imply the inclusion of stated elements but not the exclusion of any other elements.

Hereinafter, an opening/closing type electromagnetic wave absorbing device according to an exemplary embodiment of the present invention will be described with reference to the accompanying drawings.

An exemplary embodiment of the present invention provides an electromagnetic wave absorbing device that employs a periodic structure technology, such as an electromagnetic band gap (EBG), and allows the entire pattern having a resistive material to properly adjust phases of a transmitting wave and a reflected wave, so that the absorbing device may have electromagnetic wave absorption characteristics. An exemplary embodiment of the present invention provides an opening/closing electromagnetic wave absorbing device that may selectively absorb and transmit electromagnetic waves having desired frequency bands, that is, may easily adjust absorption characteristics.

According to an exemplary embodiment of the present invention, when an FSS that is a product of the above-mentioned periodic structure technology is inserted between the dielectric spacer and resistive surface of Salisbury screen, the thickness and absorption capability may be adjusted by unique electromagnetic properties of the FSS. The resultant electromagnetic wave absorber has a structure in which a resistance surface is added to a typical EBG structure. Further, when the EBG unit cell pattern itself is changed in material from the metallic conductor to a resistive material, the resistive EBG itself may function as a simpler electromagnetic wave absorber.

The resistive EBG electromagnetic wave absorber may be manufactured with less cost and more simplicity than existing electromagnetic wave absorbers for purposes of reducing multi-reflection of electromagnetic waves.

In particular, the resistive EBG electromagnetic wave absorber has an advantage of be capable of selectively absorbing electromagnetic waves having a desired frequency band, and thus, may be advantageously utilized in an environment where various bandwidths of electromagnetic waves are co-existent. Addition of an opening/closing function to the absorber allows a user to selectively absorb the electromagnetic waves at his/her convenience.

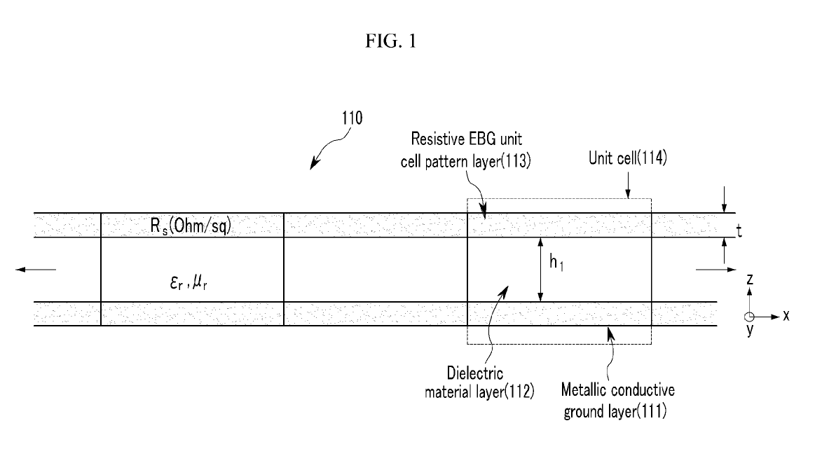

FIG. 1 is a cross section view illustrating part of an electromagnetic wave absorbing device according to an exemplary embodiment of the present invention.

Although one unit device 110 included in the electromagnetic wave absorbing device 100 is only illustrated in a front cross sectional view in FIG. 1 for convenience of illustration, the present invention is not limited thereto. The electromagnetic wave absorbing device 100 according to the embodiment of the present invention includes a plurality of unit devices 110 periodically arranged.

The unit device 110 includes a metallic conductive ground layer 111, a dielectric material layer 112 formed on the metallic conductive ground layer 111 and an EBG unit cell pattern layer 113 formed of a resistive material on the dielectric material layer 112. The unit device 110 may be divided in a plurality of EBG unit cells 114 (hereinafter, referred to “unit cells” for purpose of brevity), each including part of the metallic conductive ground layer 111, part of the dielectric material layer 112, and part of the EBG unit cells pattern layer 113 (hereinafter, referred to as “unit cell pattern layer” for purpose of brevity).

A plurality of unit devices 110 are periodically arranged to constitute the electromagnetic wave absorbing device 100. The electromagnetic wave absorbing device 100 may be adapted to have an opening/closing structure shaped as a curtain, a blind, or a shutter to selectively absorb electromagnetic waves.

The unit cell pattern layer 113 is formed to periodically arrange a specific unit cell pattern on an electric conductor at a predetermined interval. By doing so, the tangential component of a magnetic field generated on the surface of the unit cell pattern layer 113 becomes zero at a specific band, so that no current may flow on the surface of the unit cell pattern layer 113.

The frequency response characteristics of the unit cell pattern layer 113 may be identified through a reflection phase. The term “reflection phase” herein refers to a difference in phase between a wave incident onto the surface of the EBG and a wave reflected by the surface of the EBG. The reflection phase of the EBG becomes zero at a resonant frequency that is a high impedance surface and varies between −180° to +180° at peripheral bands with respect to the resonant frequency. The phrase may be changed by adjusting the structural parameters of the EBG.

The unit cell 114 is obtained by adding a loss to a frequency selective surface (FSS) including the dielectric material layer 112 and the unit cell pattern layer 113 made of a resistive material in the unit device 110. The unit cell 114 partially reflects and transmits the incident wave at a desired frequency and adjusts the phrase of a wave in the dielectric material.

That is, the dielectric material layer 112 and the unit cell pattern layer 113 included in the unit cell 114 are surfaces obtained by periodically arranging a specific unit cell pattern to selectively reflect or transmit a wave having a desired frequency. Accordingly, the unit cell 114 includes the metallic conductive ground surface with respect to filtering characteristics of a specific frequency by the FSS to completely shield the travelling of electromagnetic waves, as well as to have the foregoing unique physical features.

The metallic conductive ground layer 111 totally reflects the electromagnetic wave partially transmitted by the unit cell pattern layer 113. As such, the unit device 110 may absorb electromagnetic waves by wholly adjusting the phase of waves in the dielectric material layer 112 so that the reflected electromagnetic waves cancel each other.

Here, the height h1 between the ground surface of the metallic conductive ground layer 111 of the unit device 110 and the unit cell pattern layer 113, dielectric material properties, such as ∈ᵣ and μᵣ, and the thickness t of the unit cell pattern may function as parameters for absorption capability, which allows the unit device 110 to adjust the absorption band and capability of electromagnetic waves.

Different design parameters may be applied to top surface and bottom surface of the unit device 110 so that electromagnetic waves having different frequency bands may be simultaneously absorbed at the top and bottom surfaces.

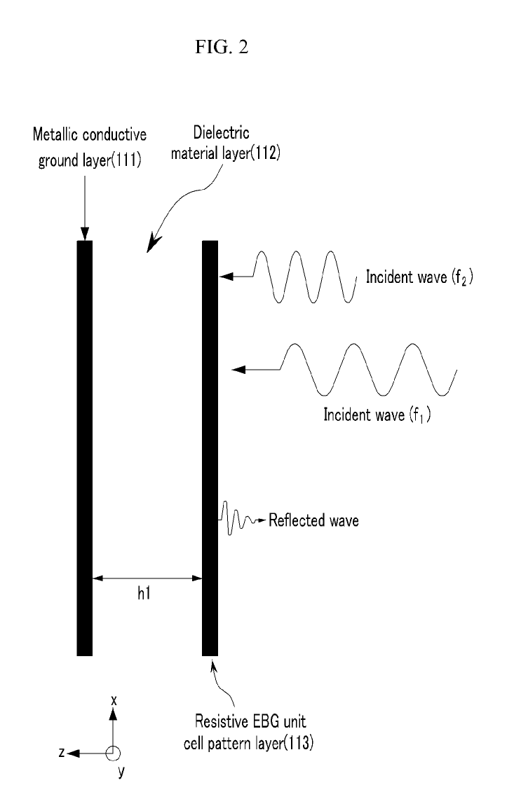

FIG. 2 is a view illustrating an absorption concept of an electromagnetic wave absorbing device according to an exemplary embodiment of the present invention.

Referring to FIG. 2, the unit device 110 according to an exemplary embodiment of the present invention may absorb nearly all of coming electromagnetic waves f1 and f2 having different frequency bands without reflection. Accordingly, the unit device 110 may have an excellent absorption capability.

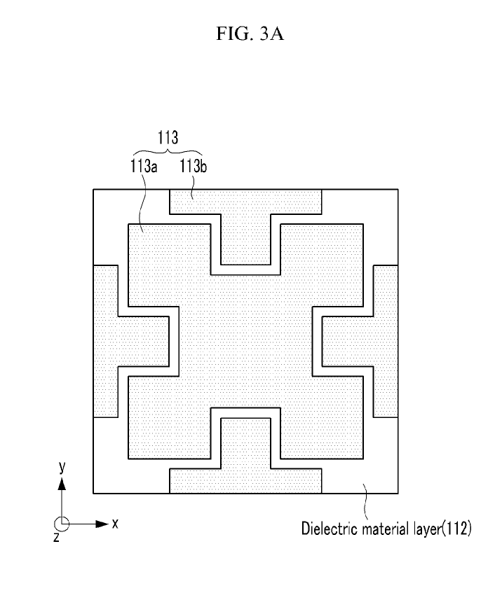

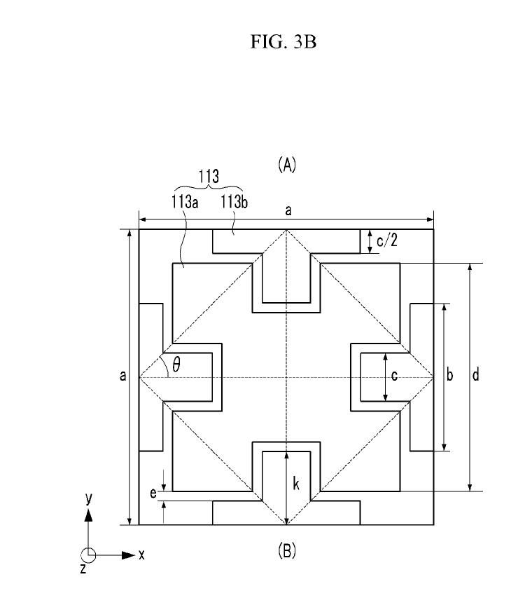

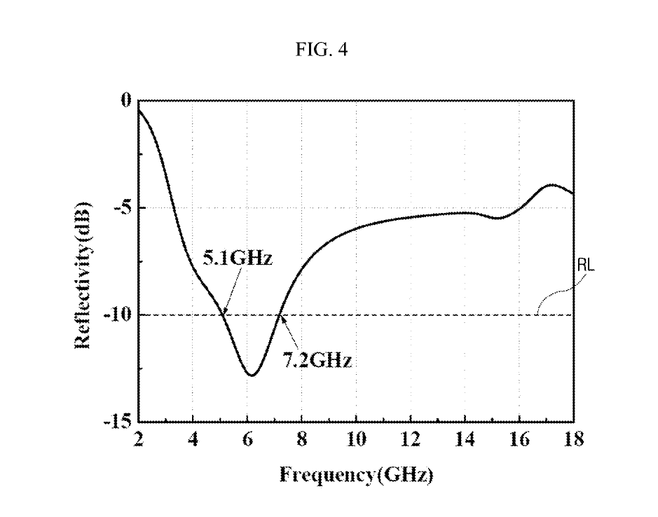

A pattern of a unit cell according to a first exemplary embodiment of the present invention, and absorption band and capability results depending on its design will now be described with reference to FIGS. 3 and 4.

FIGS. 3A and 3B illustrate a pattern structure of a unit cell and design parameters of the unit cell pattern structure according to a first exemplary embodiment of the present invention.

Referring to FIG. 3A, which is a plan view illustrating a pattern structure of a unit cell included in the unit cell pattern layer 113 according to the first exemplary embodiment of the present invention, the unit cell pattern layer 113 includes a first pattern layer 113a and a second pattern layer 113b.

The first pattern layer 113a has a polygonal structure pattern that is overall shaped as a square each side of which has a rectangular depressed portion at its central portion.

The second pattern layer 113b may be provided, each of which is shaped as the letter “T” with a predetermined thickness. An end of the T-shaped second pattern layer 113b is extended toward the rectangular depressed portion of the first pattern layer 113a in a manner to be inserted into the rectangular depressed portion.

The first pattern layer 113a and the second pattern layer 113b are spaced apart from each other at a predetermined distance.

FIG. 3B shows detailed design values according to the pattern structures of the first pattern layer 113a and the second pattern layer 113b of the unit cell pattern layer 113 shown in FIG. 3A.

FIG. 4 is a graph illustrating electromagnetic wave absorption bands and absorption capability results of the unit cell pattern structure according to the first exemplary embodiment of the present invention.

In particular, FIG. 4 shows the electromagnetic wave absorption capability and bandwidth when the unit cell pattern structure shown in FIG. 3B according to the first exemplary embodiment of the present invention has the following parameters: Rs=40 Ohm/sq, a=30 mm, b=15 mm, c=5 mm, d=23 mm, e=1 mm, h=5 mm, k=7.5 mm, t=0.001 mm, θ=45° ∈ᵣ=1, and μᵣ=1. The reflectivity that represents the absorption capability is defined as the following Equation 1:

R(dB)=20×log(r_{DUT}−r_{G}) (Equation 1)

where R is a reflectivity, r_{DUT} is a reflection coefficient of an electromagnetic wave absorber, and r_{G} is a reflection coefficient of the surface of a metal conductor.

According to the first exemplary embodiment of the present invention, when the absorption band is determined with respect to −10 dB, the reflectivity of −10 dB means absorbing 90% of an incident electromagnetic wave. Since the frequency band having a reflectivity of −10 dB reference line (RL) or less ranges from 5.1 GHz to 7.2 GHz, the frequency band is 5.1 GHz to 7.2 GHz.

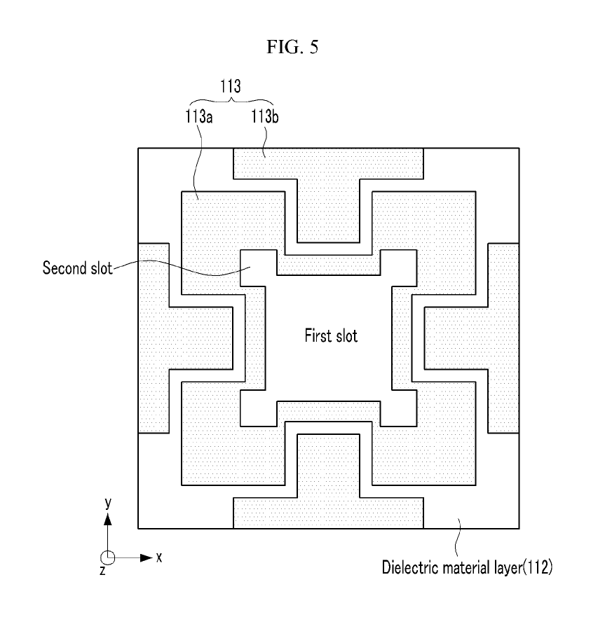

A pattern of a unit cell according to a second exemplary embodiment of the present invention and absorption bands and capability results depending on its design will now be described with reference to FIGS. 5 to 9.

FIG. 5 is a plan view illustrating a pattern structure of a unit cell according to a second exemplary embodiment of the present invention.

Referring to FIG. 5, the unit cell pattern layer 113 according to the second exemplary embodiment has a similar structure to the pattern structure according to the first exemplary embodiment of FIG. 3. However, the pattern structure shown in FIG. 5 is partially different from the pattern structure shown in FIG. 3. Specifically, the unit cell pattern layer 113 according to the second exemplary embodiment of the present invention has a rectangular first slot at the central portion of the first pattern layer 113a and rectangular second slots extended from four edges of the first slot unlike the first exemplary embodiment. The pattern structure of the unit cell according to the second exemplary embodiment may have a broad absorption band and higher maximum absorption frequency than those according to the first exemplary embodiment.

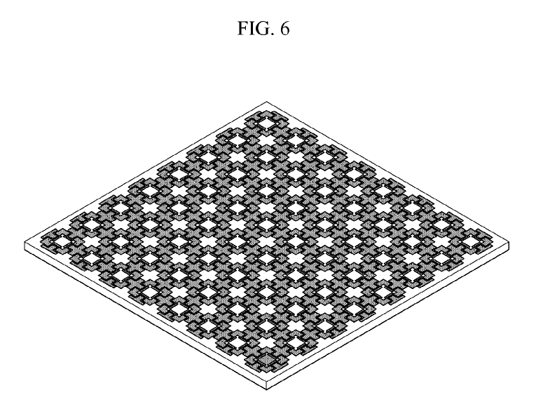

FIG. 6 is a photograph illustrating an electromagnetic wave absorber actually manufactured based on the unit cell structure according to the second exemplary embodiment.

Referring to FIG. 6, the unit cell pattern shown in FIG. 5, which is based on the structure shown in FIG. 3, is periodically arranged on the dielectric material layer 112.

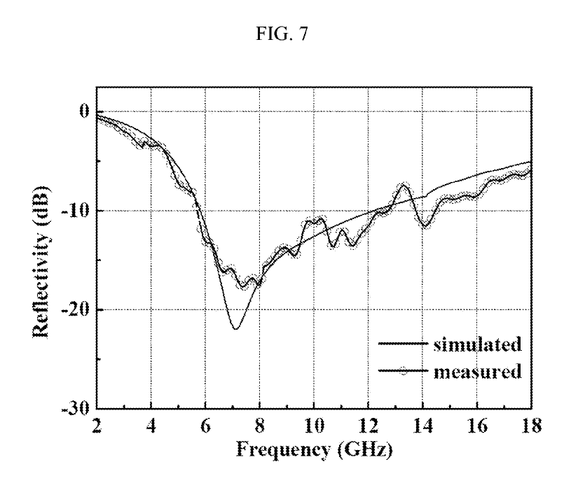

FIG. 7 is a graph illustrating electromagnetic wave absorption bands and results of absorption capability obtained by using the unit cell pattern structure according to the second exemplary embodiment of the present invention.

FIG. 7 shows simulated results obtained by the electromagnetic wave absorber manufactured according to the second exemplary embodiment described in connection with FIG. 6 and results actually measured. It can be seen in FIG. 7 that the simulated results are substantially equal to the measured results of the electromagnetic wave absorber.

It can also be seen in FIG. 7 that the maximum absorption frequency is raised and the absorption bandwidth is significantly broadened compared to the results according to the first exemplary embodiment described in connection with FIG. 3.

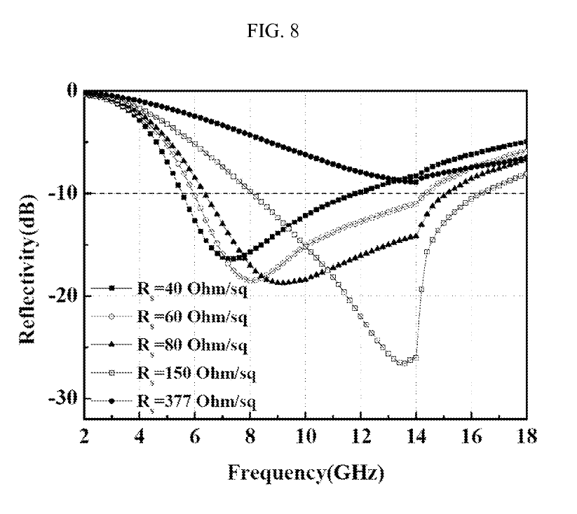

FIG. 8 is a graph illustrating results of absorption capability depending on variation of the surface resistance Rs of a unit cell pattern in a unit cell structure according to a second exemplary embodiment of the present invention.

FIG. 8 shows simulated results of absorption capability obtained by varying the surface resistance Rs of a unit cell pattern to 40, 60, 80, 150, and 377 Ohm/sq based on the unit cell structure shown in FIG. 6. It can be seen from FIG. 8 that the present invention may greatly adjust the maximum absorption frequency and absorption bandwidth by simply changing the surface resistance Rs of the unit cell pattern.

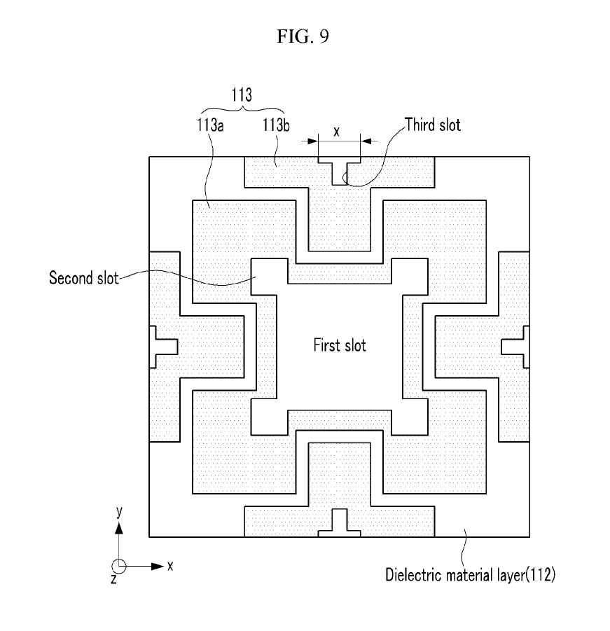

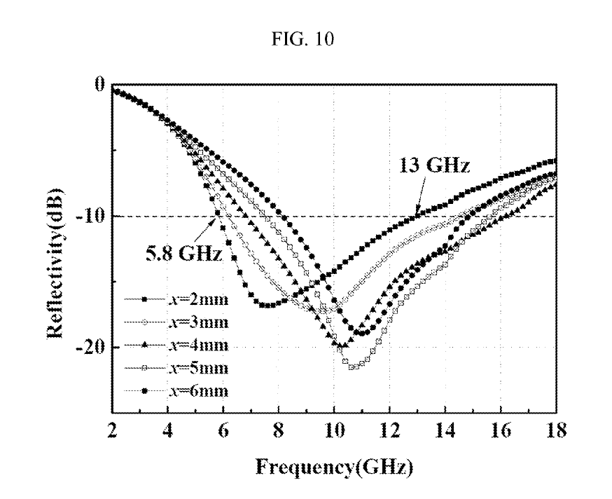

A unit cell pattern according to a third exemplary embodiment of the present invention and the absorption band and capability according to its design will now be described with reference to FIGS. 9 and 10.

FIG. 9 is a plan view illustrating a pattern structure of a unit cell according to a third exemplary embodiment of the present invention.

Referring to FIG. 9, the unit cell pattern layer 113 according to the third exemplary embodiment has a similar structure to the pattern structure according to the second exemplary embodiment of FIG. 6 except that each second pattern layer 113b of the unit cell has a T-shaped third slot at the central portion.

FIG. 10 is a graph illustrating simulated results depending on a parameter, such as the length x of a side of the third slot, according to the third exemplary embodiment of the present invention.

That is, FIG. 10 shows simulated results that can be obtained by varying the length x of the side of the third slot, which is an additional parameter other than the design parameters provided in FIG. 9.

It can be seen from FIG. 10 that the absorption capability may be easily adjusted by controlling the physical parameters as in the second exemplary embodiment.

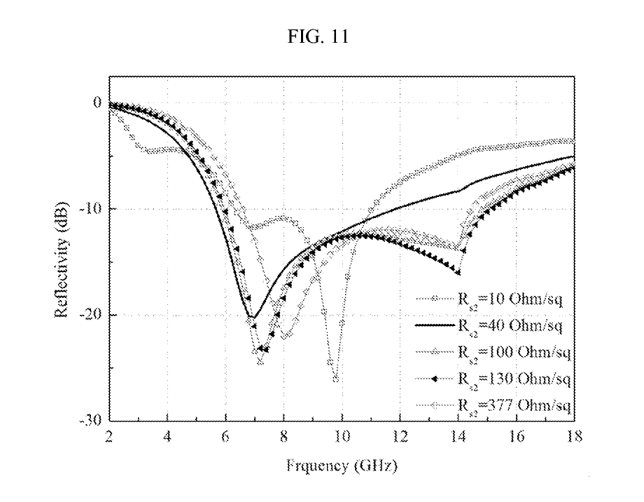

FIG. 11 shows results of absorption capability obtained by applying a different surface resistance Rs for each unit cell pattern in a unit cell structure according to an exemplary embodiment of the present invention.

The exemplary embodiments described in connection with FIGS. 3, 5, and 9 include a first pattern layer arranged in a central portion of the unit cell structure (hereinafter, referred to as “patch located in the central portion”) and second and third pattern layers arranged around the first pattern layer (hereinafter, referred to as “half cross dipole patch”). The whole unit cell patterns described above have the same resistance Rs, and their absorption capability may be changed by adjusting the resistance Rs.

According to an exemplary embodiment of the present invention, the absorption capability may be further improved by making each of the plurality of pattern layers different in surface resistance from the others, but not by applying the same resistance. That is, the absorption bandwidth and the absorption level may be further improved.

For example, by changing the surface resistance of the first pattern layer to another value while the surface resistance of the half cross patch arranged around the first pattern layer is fixed to the predetermined value (designed so that the whole resistances are the same), a resonant frequency for absorption owned by the existing half cross dipole patch is formed to be different from a resonant frequency of the first pattern layer (patch located in the central portion), so that reflectivity characteristics appear as their overlapped (mixed) results. Accordingly, it can be possible to acquire an absorption bandwidth that is wider than an absorption bandwidth obtainable by the existing structure with the same surface resistance.

Referring to FIG. 11, it can be seen that a significantly wide absorption bandwidth and a further improved absorption level may be obtained when Rs2 is larger than the existing value, i.e., 40 ohm/sq as shown in FIG. 11 while calculating reflectivity by changing the resistance (Rs, Rs2 in FIG. 11) of the first pattern layer (patch located in the central portion) from 10 ohm/sq to 377 ohm/sq, with the resistance Rs of the second pattern layer (half cross dipole patch) fixed to the existing value, 40 ohm/sq, based on the structure shown in FIG. 5.

In particular, the best capability may be acquired when Rs2 is 100 or 130 ohm/sq. This is a result obtained by performing a three-dimensional simulation based on a FEM (Finite Element Method) like the above-suggested results.

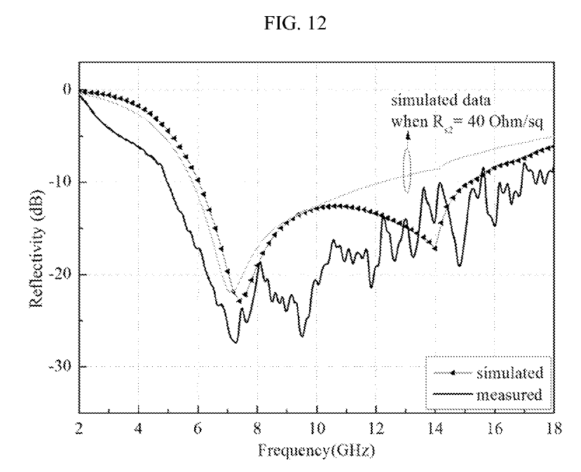

On the other hand, FIG. 12 shows results of absorption capability obtained by applying a different surface resistance Rs for each unit cell pattern in a unit cell structure actually manufactured according to an exemplary embodiment of the present invention.

Referring to FIG. 12, according to the result that the best capability is obtained when Rs2 is 100 or 130 ohm/sq as shown in FIG. 11, the surface resistance Rs1 of the second pattern layer (half cross dipole patch) is formed to be 40 ohm/sq and the surface resistance Rs2 of the first pattern layer (patch located in the central portion) is formed to be 130 ohm/sq. As a consequence, it can be seen in FIG. 11 that a significantly wide bandwidth and an improved absorption level may be acquired when the surface resistance of the first pattern layer (patch located in the central portion) is formed to be 130 ohm/sq than when both of the patches have the same resistance Rs as 40 ohm/sq. Further, it can be also seen that the actually measured results show further improved capability than that of the simulated results.

Meanwhile, the description referring to FIG. 11 and FIG. 12 is related to a theory that improves the bandwidth and the absorption level by differentiating resistances Rs of the two patches in one unit cell structure of FIG. 5. According to an additional exemplary embodiment of the present invention based on the theory, the bandwidth and the absorption level can be improved through arrangement of the unit cells.

For example, the absorption capability is changed when the resistance Rs of the unit cell structure of FIG. 5 is changed as in FIG. 8. When periodically arranging the unit cells as shown in FIG. 6, unit cells having the same unit cell pattern and different surface resistance values may be alternately arranged. In this case, a pair of unit cells that are alternately arranged and have different surface resistance values may form one unit cell.

On the contrary, when periodically arranging the unit cells as shown in FIG. 6, the entire unit cell structure may be formed by alternately arranging unit cells having one resistance Rs and different pattern structures. In this case, like to the above description, a pair of unit cells having different pattern structures may form one unit cell.

Finally, when periodically arranging the unit cells as shown in FIG. 6, unit cells having different structures and different surface resistance values may be alternately arranged.

Such an arrangement method is not limited to the two surface resistance or unit cell structures, and various resistance and unit cell structures may be applied to the arrangement.

Such a hybrid structure has an advantage that, as previously described, a resonance characteristic of a unit cell, generated by one structure/surface resistance is added with a resonance characteristic of another unit cell such that an absorption bandwidth and an absorption level can be improved. That is, the absorption bandwidth and the absorption level become controllable.

As such, as can be seen from FIGS. 3 to 12, the electromagnetic wave absorbing device according to the exemplary embodiment of the present invention may easily adjust the absorption capability (absorption bandwidth and maximum absorption frequency) by simply varying the physical parameters and electrical parameters of the unit cell structure in the unit cell pattern layer 113.

The unit cells having absorption capability may selectively and simultaneously absorb electromagnetic waves having different frequency bands.

Although the exemplary embodiments of the present invention have been described, the present invention may be embodied as various modifications without being limited to the embodiments.

For example, although the absorption capability achievable as an electromagnetic wave absorber has been primarily described in the exemplary embodiments of the present invention described in connection with FIGS. 3, 5, and 9, the present invention is not limited thereto. An opening/closing type electromagnetic wave absorbing device may include an opening/closing means capable of selectively opening or closing a limited space, wherein the unit cells are periodically arranged on the opening/closing means.

The opening/closing means may include, for example, a curtain type, a blind type, a shutter type, and a roll screen type.

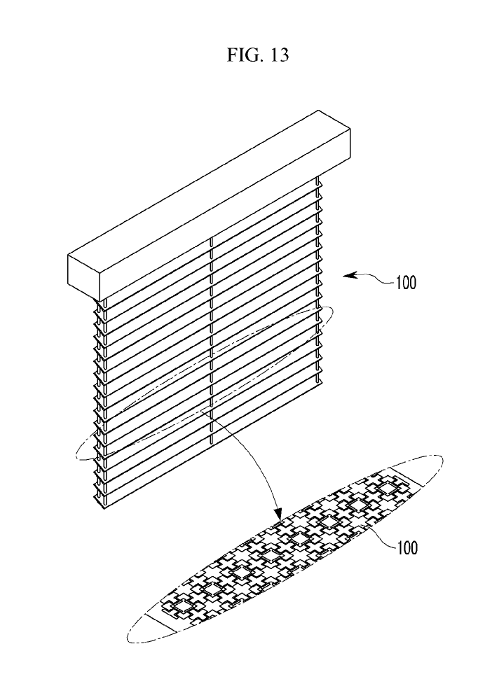

FIG. 13 is a view illustrating an electromagnetic wave absorbing device manufactured in a blind type according to an exemplary embodiment of the present invention.

Referring to FIG. 13, the blind type electromagnetic wave absorbing device 100 includes a plurality of vanes, each of which has a surface on which the unit device 110 is mounted. The blind type electromagnetic wave absorbing device may be installed on a wall surface or window of a building to selectively absorb electromagnetic waves emitted from the interior or exterior.

More specifically, when applied to curtains, blinds, or shutters in facilities, such as homes, schools, libraries, and hospitals, the electromagnetic wave absorbing device according to the present invention may effectively absorb electromagnetic waves at user's convenience while simultaneously serving as existing curtains, blinds, or shutters. Accordingly, a user may be prevented from being directly or indirectly affected by electromagnetic waves at his/her choice. The present invention may sufficiently satisfy needs of users in pursuit of well-being environments, and thus, applicable to various areas.

According to an exemplary embodiment of the present invention, the absorption capability (absorption bandwidth and maximum absorption frequency) of an electromagnetic wave absorbing device may be easily adjusted by simply varying the physical parameters and electrical parameters of the unit cell structure in the unit cell pattern layer. According to an exemplary embodiment of the present invention, the unit cells having absorption capability may selectively and simultaneously absorb electromagnetic waves having different frequency bands.

The above-mentioned exemplary embodiments of the present invention are not embodied only by an apparatus and/or method. Alternatively, the above-mentioned exemplary embodiments may be embodied by an apparatus performing various opening and closing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An opening/closing type electromagnetic wave absorbing device comprising:
a plurality of electromagnetic band gap (EBG) unit cells each of which is polygonal and selectively transmits or reflects a wave with a predetermined frequency; and
an opening/closing means on which the plurality of EBG unit cells are periodically arranged to selectively open and close a limited space,
wherein each of the plurality of EBG unit cell includes
a metallic conductive ground layer;
a dielectric layer formed on the metallic conductive ground layer;
an EBG unit cell pattern layer formed of a resistive material on the dielectric layer.

2. The device of claim 1, wherein:
the EBG unit cell pattern layer
adjusts an absorption frequency band and an absorption characteristic by controlling a structural parameter of the EBG.

3. The device of claim 2, wherein:
the EBG unit cell pattern layer
varies a reflection phase based on the parameter, wherein the phase becomes zero at a resonant frequency which is a high impedance surface and varies between −180° and +180° at a peripheral band with respect to the resonant frequency.

4. The device of claim 2, wherein:
the parameter includes
at least one of a height between a ground surface of the metallic conductive ground layer and the EBG unit cell pattern layer, dielectric material properties, and a thickness of the unit cell pattern.

5. The device of claim 4, wherein:
EBG unit cells with different parameters are arranged on top and bottom surfaces of the metallic conductive ground layer so that electromagnetic waves having different frequency bands are absorbed at both of the top and bottom surfaces.

6. The device of claim 1, wherein:
the metallic conductive ground layer
totally reflects an electromagnetic wave partially transmitted by the EBG unit cell pattern layer.

7. The device of claim 1, wherein:
the EBG unit cell pattern layer includes
a first pattern layer that has a polygonal structure pattern that is overall shaped as a square each side of which has a rectangular depressed portion at its central portion; and
a second pattern layer shaped as the letter “T” with a predetermined thickness,
wherein an end of the T-shaped second pattern layer is extended toward the rectangular depressed portion of the first pattern layer in a manner to be inserted into the rectangular depressed portion.

8. The device of claim 7, wherein:
the first pattern layer includes
a rectangular first slot shaped at the central portion and rectangular second slots extended from four edges of the first slot.

9. The device of claim 8, wherein:
the second pattern layer further includes
a T-shaped third slot at the central portion.

10. The device of claim 1, wherein:
the opening/closing means includes
any one of a curtain type, a blind type, and a shutter type.

11. The device of claim 1, wherein:
the EBG unit cell pattern layer adjusts at least one of a maximum absorption frequency and an absorption bandwidth by varying a surface resistance.

12. The device of claim 7, wherein:
at least one of a maximum absorption frequency and an absorption bandwidth is adjusted by applying a surface resistance of the first pattern layer different from a surface resistance of the second pattern layer.

13. The device of claim 12, wherein:
a capability in bandwidth is improved by making the surface resistance of the first pattern layer larger than at least the surface resistance of the second pattern layer, with the surface resistance of the second pattern layer fixed to a same value.

14. The device of claim 1, wherein when EBG unit cells are periodically arranged, at least one of a unit cell structure or a unit cell surface resistance is differentiated in the alternate arrangement.

15. The device of claim 13, wherein when EBG unit cells are periodically arranged, at least one of a unit cell structure or a unit cell surface resistance is differentiated in the alternate arrangement.
